(19) United States
(12) Patent Application Publication
(10) Pub. No.: US 2004/0206086 A1
(43) Pub. Date: Oct. 21, 2004

(54) High altitude construction with a buoyant device

(76) Inventor: Dong Ho Kim, Los Angeles, CA (US)

Correspondence Address: PARK & SUTTON LLP, 3255 WILSHIRE BLVD, SUITE 1110, LOS ANGELES, CA, 90010, US

(21) Appl. No.: 10/417,504

(22) Filed: Apr. 17, 2003

(51) Int. Cl. B60K 16/00; B60L 8/00; F03G 7/00; F03G 6/00

(52) U.S. Cl. 60/641.8; 60/641.11; 60/641.15

(57) ABSTRACT

A high altitude construction including a buoyant device, a base installed on the ground level, a conduit connecting the buoyant device and the base, and an air raising device is provided. The air raising device includes a heating device for heating air. Air heated by the heating device passes through the conduit from the base to the buoyant device, and the heated air provides buoyant force to the buoyant device so that the buoyant device floats in the atmosphere and the conduit is suspended between the buoyant device and the base. The base also includes a turbine and an electricity generator connected to the turbine. The turbine is rotated by air flow in the conduit from the base to the buoyant device.

### BACKGROUND OF THE INVENTION

The present invention relates to a high altitude construction with a buoyant device. More particularly, the invention relates to a high altitude construction that uses heated air to buoy the buoyant device, and generates electricity using air stream within the construction.

High altitude constructions including a steel tower for power transmission, a tall building, and facilities on a mountain summit, etc. are useful for various purposes. In many cases, it is better if the height of such construction is higher. Construction cost and technical difficulties limited the practical height of the high altitude constructions.

A high altitude construction also has a potential for a facility utilizing energy of the atmosphere.

Modern civilization caused dramatic increase of the demand for energy as per the rapid development of technology and the expansion of economy scale. Fossil fuels such as coal, petroleum, and natural gas, which supply most of the energy, will eventually be exhausted. Also, the buried amounts of fossil fuels are concentrated in specific areas.

Another disadvantage of the fossil fuel is that air pollutants including CO₂, NOₓ, and SOₓ are generated by combustion of fossil fuel, and they not only pollutes the air directly, but also causes serious environmental problems including destruction of the ozone layer, and the greenhouse effect, etc.

These disadvantages were clearly revealed through the two oil shocks in the nineteen-seventies. They motivated development of substitute energies that can replace petroleum and generates no pollution.

The concept of solar energy has changed from the broad meaning of non-petroleum energy source including coal, nuclear reaction energy, and natural gas, etc. to a new, clean and safe regeneration energy that produces no pollution and uses new technology. Accordingly, the purposes of solar energy technology development are securing future energy resource first, and expediting environment-friendly energy resource development.

Thermal power generation using petroleum or coal as fuel is a main method for generating electric power. In addition, there are methods using hydraulic power, wind or tide. Recently, methods using geothermal energy, solar energy, and nuclear reaction energy are known.

Thermal power generation is not preferred since fossil fuel is being exhausted as mentioned earlier. Hydraulic power generation does not use fuel, but is difficult to construct since initial investment for constructing a dam for containing water and facilities for falling water is too large.

Nuclear power generation is sought considering the above factors. However, it requires a large cost for constructing facilities, and measures for securing safety. Other efforts for substitute energy include methods using wind, tide, geothermal energy, or solar energy.

While atmospheric pressure is another energy source that can be found anywhere globally, method for using atmospheric pressure is not known.

### SUMMARY OF THE INVENTION

The present invention contrives to solve the disadvantages of prior art.

Therefore an object of the invention is to provide a high altitude construction with a buoyant device, which can be used to serve various high altitude tasks.

Another object of the invention is to provide a high altitude construction with a buoyant device and a electricity generating facility.

To achieve the above-described objects, the invention provides a high altitude construction that includes a buoyant device, a base installed on the ground level, a conduit connecting the buoyant device and the base and an air raising device for raising air so that air flows from the base to the buoyant device through the conduit.

The air raising device includes a heating device for heating air. Air heated by the heating device passes through the conduit from the base to the buoyant device, and the heated air provides buoyant force to the buoyant device so that the buoyant device floats in the atmosphere and the conduit is suspended between the buoyant device and the base.

The base further includes a turbine and a generator connected to the turbine. The turbine is rotated by air flow in the conduit from the base to the buoyant device.

The buoyant device is a balloon that contains the heated air supplied through the conduit. The balloon has an air exit for controlling air exhaust rate from the balloon. The air exit includes an iris diaphragm.

The conduit includes a plurality of wires, and a band wound around the wires.

The heating device may use solar energy or geothermal energy as an energy source.

The base includes a hollow, cone-shaped tower, the diameter of which reduces upward, and the tower has an upper end that is connected with the conduit.

The base further includes a vent that can selectively supply outside air into the base.

The heating device may further include one or more burners that are installed inside the tower.

The heating device includes a plurality of solar energy collectors, a plurality of heat reservoirs that are connected to the solar energy collectors and accumulate the collected solar energy, and a plurality of air ducts that connect the heat reservoirs to the tower. Each of the heat reservoirs has a stone member buried underground, and each of the solar energy collectors has a heat collecting plate and a heat transfer fin that transfers heat from the heat collecting plate to the stone member.

The heating device further includes a heat extracting device that extracts heat from the heat reservoirs. The heat extracting device includes a fluid tank and a plurality of heat extracting tubes connected to the fluid tank. The fluid tank includes a first fluid chamber, a first fluid passage provided on the first fluid tank, a second fluid chamber and a second fluid passage provide on the second fluid tank. Each of the heat extracting tubes includes an inner tube and an outer tube. The inner tube is positioned inside the outer tube for a predetermined length. The inner tube includes a first end and a second end. The outer tube includes a first end and a second end. The first end of the inner tube is connected to the second fluid chamber and the first end of the outer tube is connected to the first fluid chamber. The second end of the outer tube is communicatively connected to the second end of the inner tube. The cross-section of the inner tube has a plurality of alternately positioned wings and recesses, and the wings are inscribed to the inner surface of the outer tube.

The heating device may further include a plurality of geothermal heat transfer pipes connected to the air ducts.

The base may further include a hollow heat collecting tube having a predetermined length between the upper end of the tower and the conduit. The heating device includes a plurality of reflectors that are arranged to reflect the sunlight to the heat collecting tube. The heat collecting tube is made of copper and painted black.

Alternately, the base is installed on the sea surface and the air raising device includes a underwater air circulation device. The underwater air circulation device is vertically positioned under the base. The underwater air circulation device intakes air on the sea surface, forms downward air flow by cooling the air by sea water, then forms upward air flow by reversing direction of the downward air flow. The upward air flow is guided into the conduit.

The underwater air circulation device has an inner tube and an outer tube. The inner tube is positioned inside the outer tube. The upper end of the outer tube is open slightly above the sea surface so that air flows into the outer tube. The lower end of the outer tube is communicatively connected to the lower end of the inner tube so that the direction of the downward air flow is reversed. In an embodiment, the lower end of the inner tube abuts the lower end of the outer tube, and the inner tube includes a plurality of holes near the lower end of the inner tube.

The outer tube of the underwater air circulation device has a plurality of heat transfer fins protruding into the space between the outer tube and the inner tube. Some of the fins are extended to contact the inner tube so that the inner tube is supported stably inside the outer tube.

A high altitude platform is made with a plurality of high altitude constructions that are constructed as explained above. A support member connects the high altitude constructions. The support member is positioned near the buoyant devices of the high altitude constructions. The support member includes a high altitude plate fixed thereto, and an aperture whereby one of the high altitude constructions can elevate cargos from the ground to the support member through the aperture.

The advantages of the present invention are numerous in that: (1) a high altitude construction is provided without a substantial investment; (2) electricity can be generated without consuming fuel and without making pollutants; and (3) a high altitude platform is provided utilizing multiple high altitude constructions.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a schematic elevation view of a high altitude construction according to the present invention;

FIG. 2 is a detailed elevation view of a buoyant device and the upper end of a conduit;

FIG. 3 is a schematic cross-sectional view of a base, a heating device and a lower end of the conduit;

FIG. 4 is a schematic perspective view showing the process of making the conduit;

FIG. 5 is a schematic drawing showing another heating device that includes reflectors focused to a heat collecting tube;

FIG. 6 is a view similar to FIG. 3 and shows a turbine and a generator installed in the construction;

FIG. 7 is a schematic elevation view showing a high altitude platform with a plurality of high altitude constructions;

FIG. 8 is a view similar to FIG. 7 and shows one of the high altitude constructions acts as an elevator and is lowered to the ground;

FIG. 9 is a schematic cross-sectional view showing a heat extracting device;

FIG. 10 is a cross-sectional view taken along the line 10-10 in FIG. 9;

FIG. 11 is a schematic cross-sectional view showing a high altitude construction installed on the sea surface;

FIG. 12 is a cross-sectional view taken along the line 12-12 in FIG. 10; and

FIG. 13 is a partial cross-sectional view of a underwater air circulation device.

### DETAILED DESCRIPTION OF THE PREFERRED EMBODIMENTS

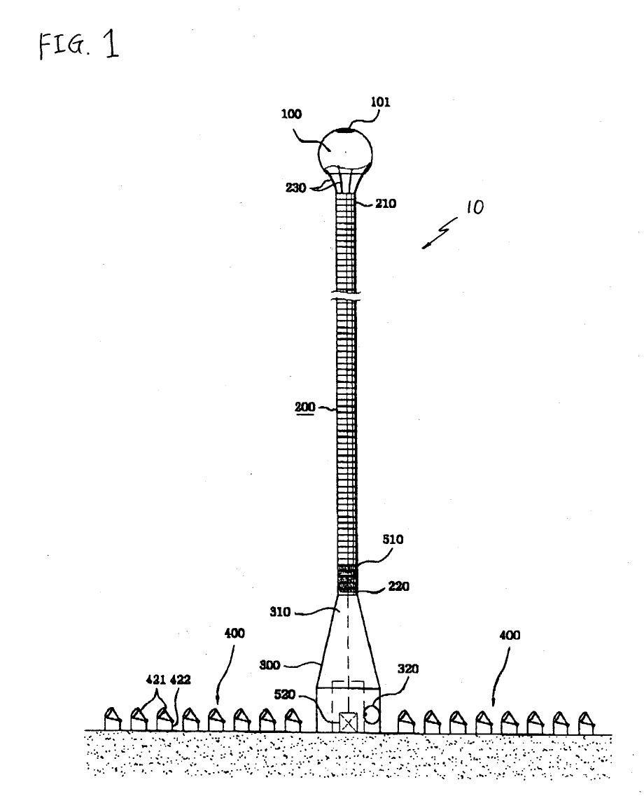

FIG. 1 shows a high altitude construction 10 according to the present invention. The construction 10 includes a buoyant device that is a balloon 100, a base 300 installed on the ground level, a conduit 200 connecting the balloon 100 and the base 300, and an air raising device for raising air so that air flows from the base 300 to the balloon 100 through the conduit 200.

In FIG. 1, the air raising device includes a heating device 400 for heating air. Air heated by the heating device 400 passes through the conduit 200 from the base 300 to the balloon 100. The balloon 100 contains the heated air supplied through the conduit 200. The heated air provides buoyant force to the balloon 100 so that the balloon 100 floats in the atmosphere and the conduit 200 is suspended between the balloon 100 and the base 300.

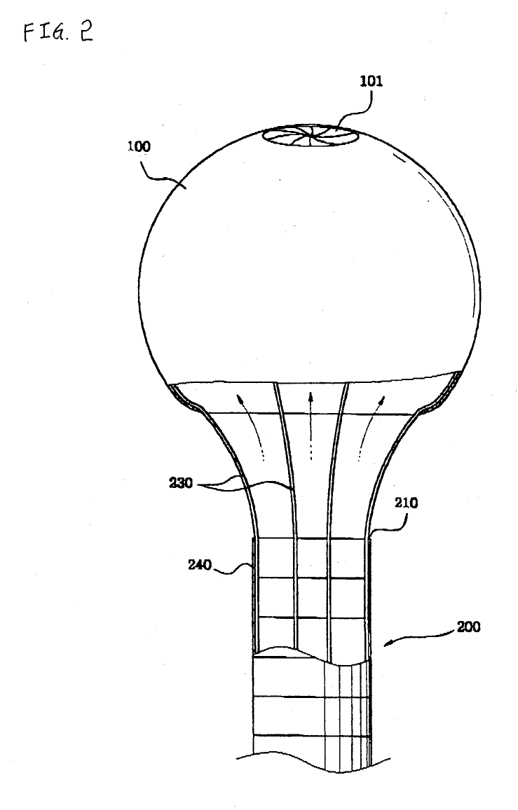

The balloon 100 has an air exit for controlling air exhaust rate from the balloon 100. In FIGS. 1 and 2, the air exit is an iris diaphragm 101. With the iris diaphragm 101, the ascending or descending rate of the balloon 100 can be controlled as required.

Alternatively, the balloon 100 can contain light weight gas such as Helium.

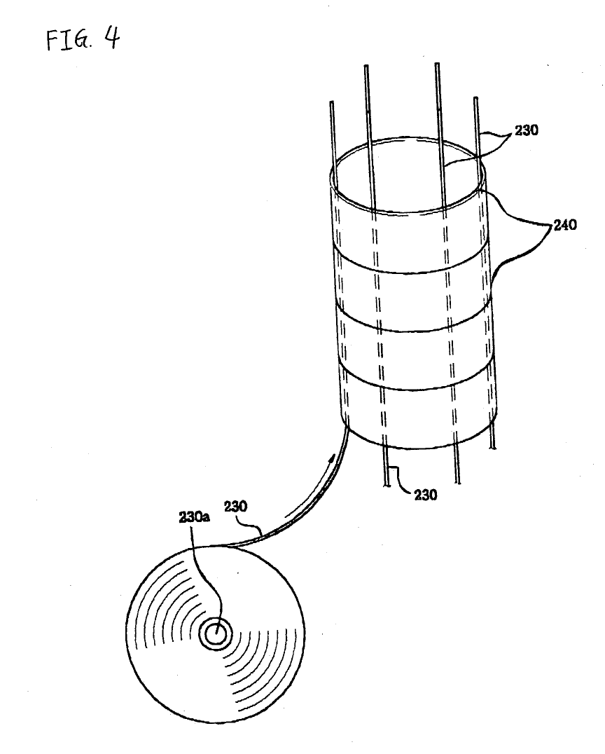

FIG. 4 shows a process of making the conduit 200. A plurality of wires 230, which are flexible and have high tensile strength, are vertically positioned forming a circular column. Then a circular band 240 is formed around the wires 230. And this process is repeated for a desired height of the conduit 200. Since the conduit 200 may be substantially long to reach a very high altitude, the conduit 200 is not assembled as a whole but is erected and raised as it is being made starting its upper end 210. The wires 230 are continuously supplied from a bobbin 230a, and the bands 240 are formed continuously. The band 240 is made of fabric or synthetic resin. The band 240 is added in a way that the conduit 200 thus made is sealed. When the conduit 200 is damaged or broken, only the bands 240 that are damaged or broken can be replaced.

When the conduit 200 has been made over a predetermined length, the balloon 100 is connected to the upper end of the conduit 200, and hot air is supplied into the conduit 200 so that the balloon 100 is buoyed and the partially made conduit 200 is suspended from the balloon 100. Under this state, the wires 230 are continuously supplied, and the bands 240 are repetitively formed until a desired length of the conduit 200 is obtained.

A location to install the high altitude construction 10 should not affect nearby facilities and have a suitable climate, etc. A suitable location includes a basin surrounded by hills in a desert. After a location is chosen, the base 300 is installed first.

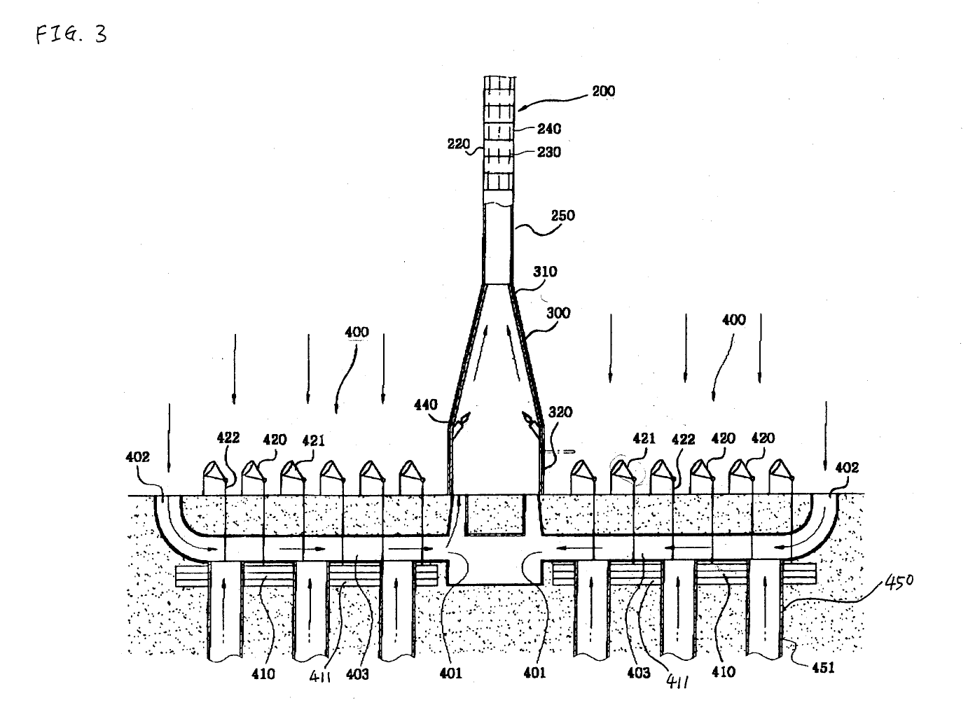

FIG. 3 shows that the base 300 is made as a hollow, cone-shaped tower, the diameter of which reduces upward. The base 300 has an upper end 310 that is connected with the lower end 220 of the conduit 200. The internal diameters of the upper end 310 of the base 300 and the lower end 220 of the conduit 200 are the same to facilitate sealing. The base also may include a hollow heat collecting tube 250 having a predetermined length between the upper end 310 of the base 300 and the conduit 200. The hollow heat collecting tube 250 is made of copper and painted black to maximize heat collecting and transferring effects. The base 300 also includes one or more vents 320 that can selectively supply unheated outside air into the base 300.

The heating device 400 is installed under the base 300. The heating device 400 utilizes a solar energy heater disclosed in the applicant's Korean Patent No. 202252, the contents of which are incorporated by reference here. Essential features of the solar energy heater are explained below.

The solar energy heater collects solar energy with collecting means such as lenses, stores the collected energy in storing means such as stones buried underground, and extracts the stored heat as required for use at heating a building, etc.

FIG. 3 also shows how the solar energy heater is utilized in the present invention. The solar energy heater includes a plurality of solar energy collector 420 that are installed on the ground near the base 300, a plurality of heat reservoirs 410 that are connected to the solar energy collectors 420 and accumulate the collected solar energy, and a plurality of air ducts 403 that connects the heat reservoirs 410 to the base 300. The heat reservoirs 420 are buried underground under the air ducts 403. The air ducts 403 are positioned underground and radially from the base 300. Each of the air ducts 403 has an air outlet 401 that is positioned directly below the base 300, and an air inlet 402 that intakes outside air. Air passing through the air ducts 403 is heated by heat stored in the heat reservoirs 410. The heated air is guided into the conduit 200 via the base 300. Heated air has smaller density, and thus has a buoyant force. This buoyant force together with atmospheric pressure difference between the upper and lower ends of the conduit 200 induce rapid flow of air within the conduit 200.

Each of the heat reservoirs 410 has a stone member 411 buried underground, and each of the solar energy collectors 420 has a heat collecting plate 421 and a heat transfer fin 422 that transfers heat from the heat collecting plate 421 to the stone member 411.

The heating device 400 may also include a means for collecting geothermal energy 450. The geothermal energy collecting means 450 includes a plurality of geothermal heat transfer pipe 451 connected to the air ducts 403. The geothermal heat transfer pipes 451 extends into the ground by a predetermined depth, and collects geothermal energy, transfers the energy to the air passing through the air ducts 403.

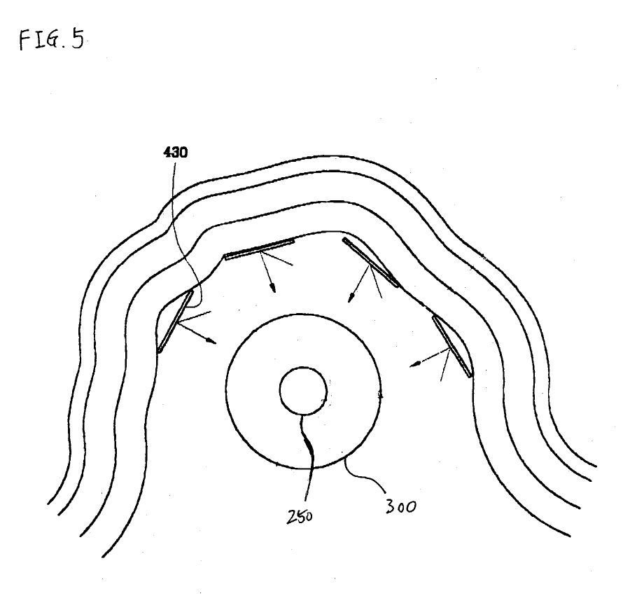

FIG. 5 shows an alternate scheme of the heating device. A plurality of reflectors 430 are arranged in an arc around the base 300. The reflectors 430 reflect the sunlight to the heat collecting tube 250. Thus solar energy is concentrated by the reflectors 430 to the heat collecting tube 250 and heats the air passing through the heat collecting tube 250. FIG. 5 also shows that the reflectors 430 are installed using geographical features such as a basin surrounded by mountains.

Referring back to FIG. 3, the heating device 400 further includes one or more burners 440 that are installed inside the base 300. The burners 440 are used to heat air when there is not enough heat in the heat reservoirs 410 due to continuous cloudy days. The burners 440 are positioned on the inner periphery of the base 300. Diesel fuel and natural gas, etc. may be used as fuels for the burners 440.

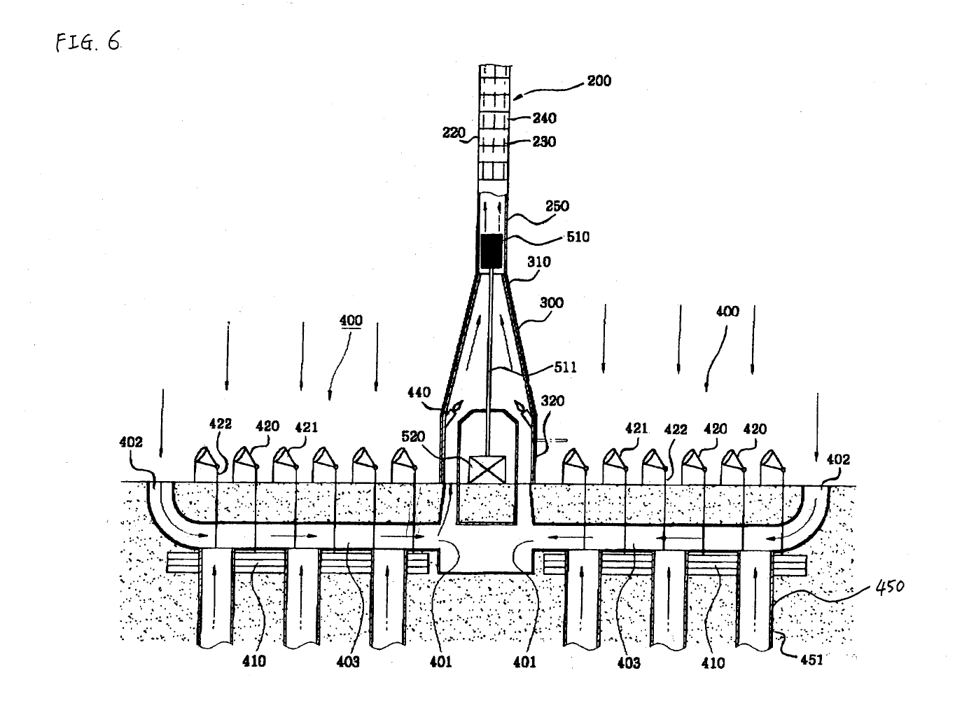

FIG. 6 shows that a turbine 510 and a generator 520 connected to the turbine 510 are provided in the high altitude construction 10. The turbine 510 is rotated by air flow in the conduit 200 from the base 300 to the buoyant device 400. The air flow gains high speed as the heated air rises with buoyant force and the atmospheric pressure difference between the lower end and the upper end of the conduit 200. The turbine 510 is rotated with the energy of this air flow. The turbine 510 is positioned inside the conduit 200 or the heat collecting tube 250. A shaft 511 connects the turbine 510 with the generator 520 that is installed on the ground.

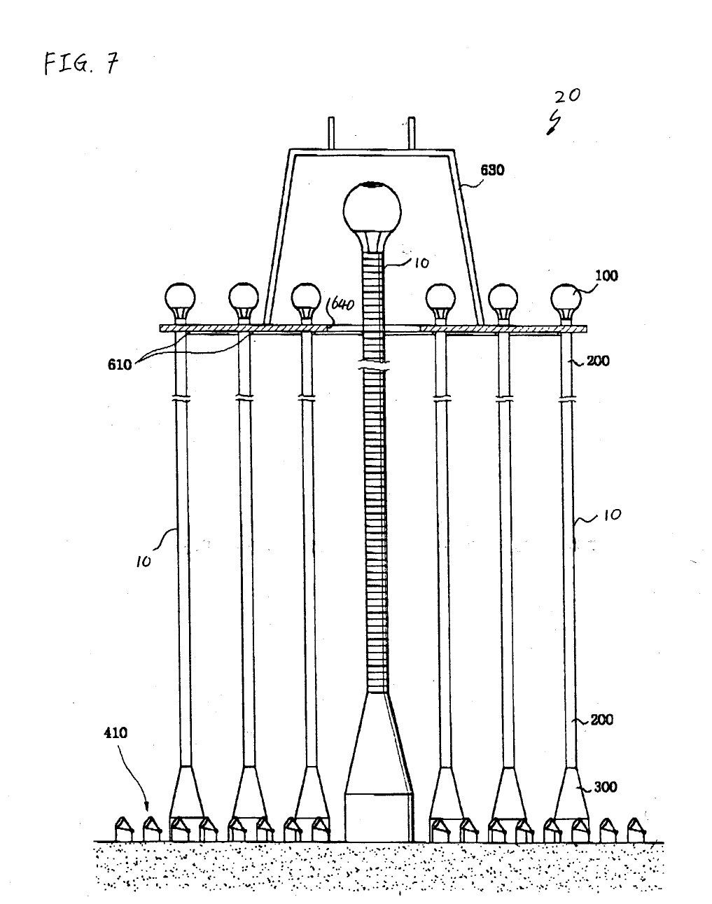

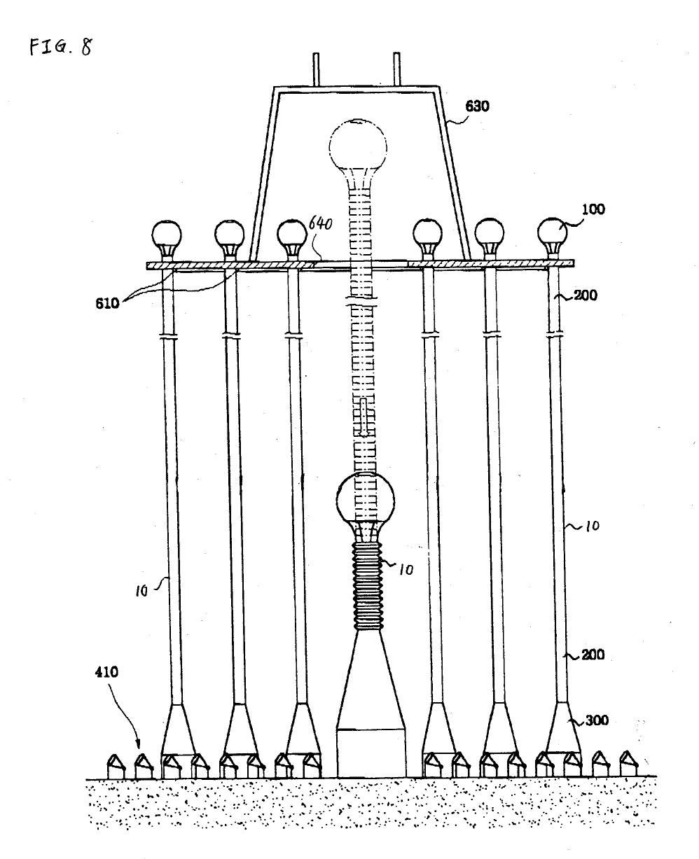

FIGS. 7 and 8 show a high altitude platform 20 that utilizes a plurality of the high altitude constructions 10. The high altitude platform 20 includes a plurality of the high altitude construction 10, and a support member 610 connecting the high altitude constructions 10. Each of the high altitude constructions 10 has a structure that is explained above. The support member 610 is positioned near the balloons 100 of the high altitude constructions 10 and connects the upper ends 210 of the conduits 200. The support member 610 includes a high altitude plate 630 fixed thereto, and an aperture 640. One of the high altitude constructions 10 that is positioned below the aperture 640 has the role of elevating cargos from the ground to the support member 610 through the aperture 640. The high altitude plate 630 may be used as a facility for launching a rocket that carries a satellite. The high altitude construction 10 can carry parts for a rocket and a satellite from the ground to the high altitude plate 630 by elevating and descending the balloon 100. The balloon 100 passes through the aperture 640 when it is raised or lowered. The rocket may be assembled on the high altitude plate 630 and launched from the high altitude plate 630 rather than from the ground.

FIG. 8 shows that the balloon 100 of the high altitude construction 10 that is used to carry cargo is descended near the ground.

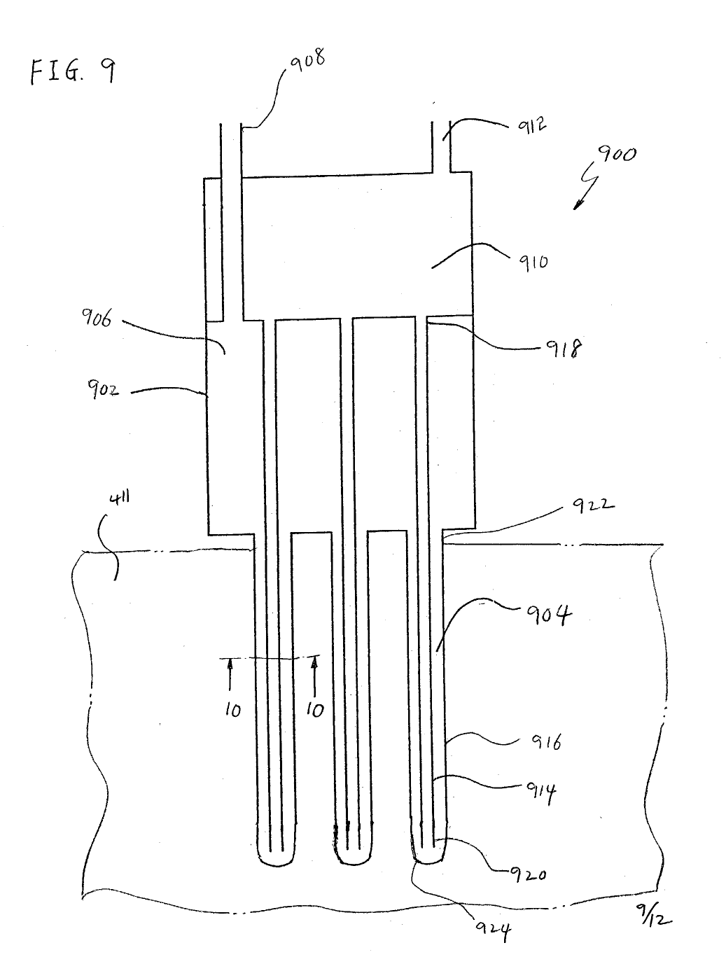

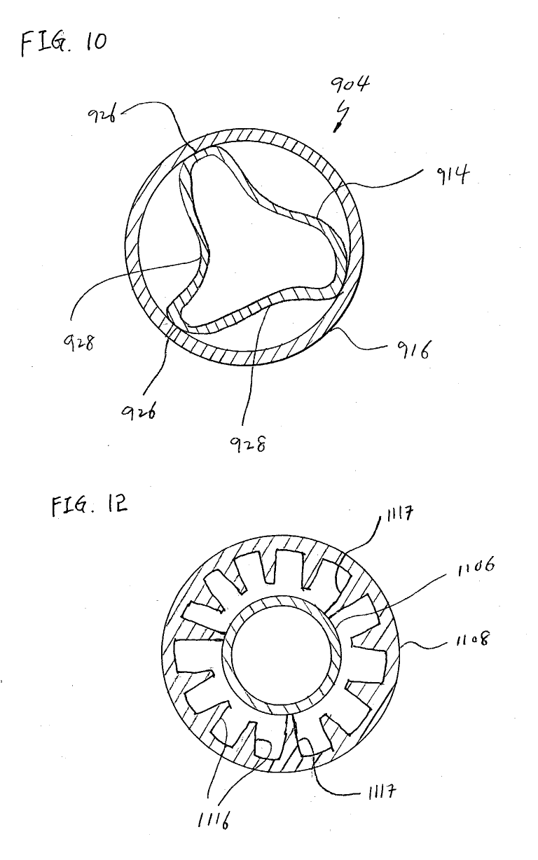

FIGS. 9 and 10 show a heat extracting device 900 that extracts heat from the heat reservoirs 410. The heat extracting device 900 utilizes a heat extracting device disclosed in the applicant's Korean Patent Publication No. 10-0212955, the contents of which are incorporated by reference here. Essential features of the heat extracting device 900 are explained below. The heat extracting device 900 includes a fluid tank 902 and a plurality of heat extracting tubes 904 connected to the fluid tank 902. The fluid tank 902 includes a first fluid chamber 906, a first fluid passage 908 provided on the first fluid chamber 906, a second fluid chamber 910 and a second fluid passage 912 provided on the second fluid chamber 910. Each of the heat extracting tubes 904 includes an inner tube 914 and an outer tube 916. The inner tube 914 is positioned inside the outer tube 916 for a predetermined length. The inner tube 914 includes a first end 918 and a second end 920 and wherein the outer tube 916 includes a first end 922 and a second end 924. The first end 918 of the inner tube 914 is connected to the second fluid chamber 910 and the first end 922 of the outer tube 916 is connected to the first fluid chamber 906. The second end 924 of the outer tube 916 is communicatively connected to the second end 920 of the inner tube 914. By this double-walled structure of the heat extracting tubes 904, the heat extracting device 900 can be installed on the stone member 411 by simply drilling holes for the heat extracting tubes 904.

Depending on the situations, either cold water flows into the first fluid passage 908, and hot water heated by the stone member 411 flows out of the second fluid passage 912, or vice versa. Heat extracted by the heat extracting device 900 is used to heat air that passes through the air ducts 403.

FIG. 10 shows that the inner tube 914 has a plurality of alternately positioned wings 926 and recesses 928. The wings 926 are inscribed to the inner surface of the outer tube 916. In this way, the double-walled heat extracting tubes 904 may be easily manufactured with off-the-shelf parts.

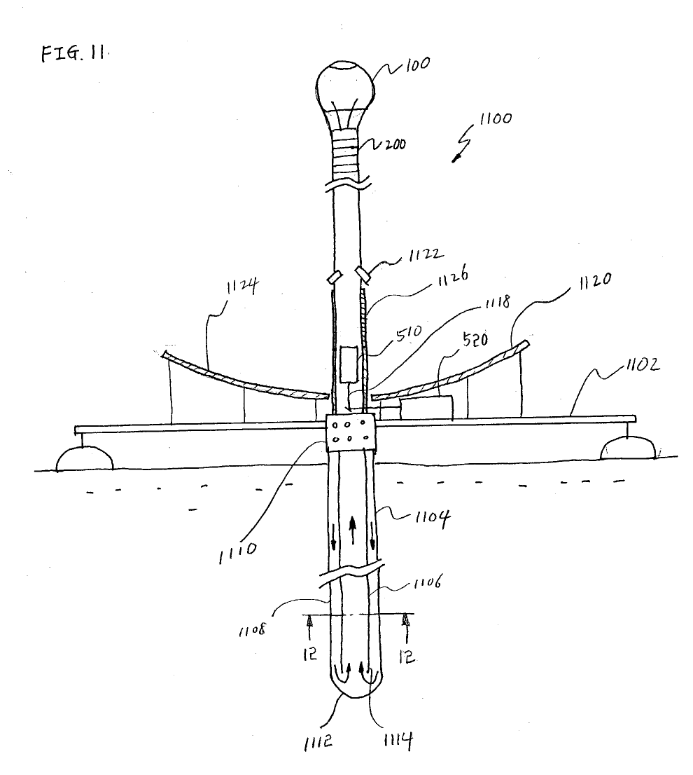

FIGS. 11, 12 and 13 show a high altitude construction 1100 that is installed on the sea surface. The high altitude construction 1100 includes the balloon 100, the conduit 200, a base 1102 that is stably supported on the sea surface, and an air raising device. The air raising device is a underwater air circulation device 1104. The underwater air circulation device 1104 is vertically positioned under the base 1102. The underwater air circulation device 1104 intakes air on the sea surface, forms downward air flow by cooling the air by sea water, then forms upward air flow by reversing direction of the downward air flow. The upward air flow is guided into the conduit 200.

The underwater air circulation device 1104 has an inner tube 1106 and an outer tube 1108. The inner tube 1106 is positioned inside the outer tube 1108. The upper end 1110 of the outer tube 1108 is open slightly above the sea surface so that air flows into the outer tube 1108. The lower end 1112 of the outer tube 1108 is communicatively connected to the lower end 1114 of the inner tube 1106 so that the direction of the downward air flow is reversed.

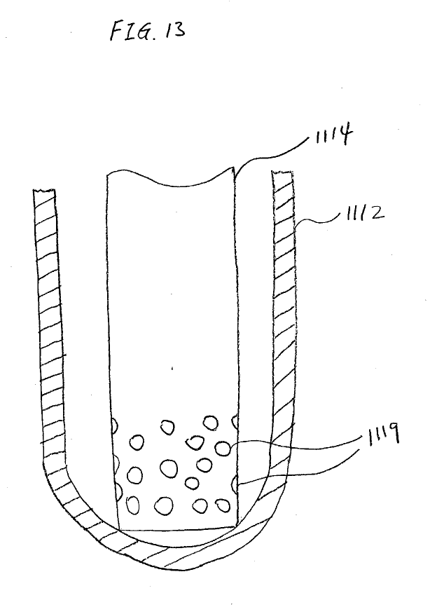

Referring to FIG. 12, the outer tube 1108 has a plurality of heat transfer fins 1116 protruding into the space between the outer tube 1108 and the inner tube 1106. Some of the heat transfer fins 1117 are extended to contact the inner tube 1106 so that the inner tube 1106 is supported stably inside the outer tube 1108.

The base 1102 includes a turbine 510 and a generator 520 connected to the turbine 510 via a transmission shaft 1118. The turbine 510 is rotated by air flow in the conduit 200 from the base 1102 to the balloon 100.

The air raising device of the high altitude construction 1100 may further include a heating device 1120 for heating air. The heating device 1120 uses solar energy as an energy source. One or more burners 1122 are installed inside the conduit 200 as a secondary heating device.

The base 1102 further includes a hollow heat collecting tube 1126 having a predetermined length. The heating device 1120 includes a plurality of reflectors 1124 that are arranged to reflect the sunlight to the heat collecting tube 1126.

Referring to FIG. 13, the lower end of the inner tube 1114 abuts the lower end of the outer tube 1112, and the inner tube 1114 includes a plurality of holes 1119 near the lower end of the inner tube so that air may be communicated through the holes 1119.

The present invention provides a high altitude construction with minimum initial investment and maintenance cost. Also a clean and economical electricity generation facility is provided. The high altitude construction can be made up to any required length. A very high altitude platform, which is useful for special activities such as launching satellites, may be provided utilizing multiple high altitude constructions.

Although the invention has been described in considerable detail, other versions are possible by converting the aforementioned construction. Therefore, the scope of the invention shall not be limited by the specification specified above.

What is claimed is:

1. A high altitude construction comprising:
a) a buoyant device;
b) a base installed on the ground level;
c) a conduit connecting the buoyant device and the base; and
d) an air raising device for raising air so that air flows from the base to the buoyant device through the conduit.

2. The high altitude construction of claim 1, wherein the air raising device includes a heating device for heating air, wherein air heated by the heating device passes through the conduit from the base to the buoyant device, wherein the heated air provides buoyant force to the buoyant device so that the buoyant device floats in the atmosphere and the conduit is suspended between the buoyant device and the base.

3. The high altitude construction of claim 2, wherein the base further comprises a turbine and a generator connected to the turbine, and wherein the turbine is rotated by air flow in the conduit from the base to the buoyant device.

4. The high altitude construction of claim 2, wherein the buoyant device is a balloon that contains the heated air supplied through the conduit.

5. The high altitude construction of claim 4, wherein the balloon has an air exit for controlling air exhaust rate from the balloon.

6. The high altitude construction of claim 5, wherein the air exit includes an iris diaphragm.

7. The high altitude construction of claim 2, wherein the conduit includes a plurality of wires, and a band wound around the wires.

8. The high altitude construction of claim 2, wherein the heating device uses solar energy as an energy source.

9. The high altitude construction of claim 8, wherein the base includes a hollow, cone-shaped tower, the diameter of which reduces upward, wherein the tower has an upper end that is connected with the conduit.

10. The high altitude construction of claim 8, wherein the base further includes a vent that can selectively supply outside air into the base.

11. The high altitude construction of claim 10, wherein the heating device further includes one or more burners that are installed inside the tower.

12. The high altitude construction of claim 8, wherein the heating device includes a plurality of solar energy collectors, a plurality of heat reservoirs that are connected to the solar energy collectors and accumulate the collected solar energy, and a plurality of air ducts that connect the heat reservoirs to the tower.

13. The high altitude construction of claim 12, wherein each of the heat reservoirs has a stone member buried underground, and each of the solar energy collectors has a heat collecting plate and a heat transfer fin that transfers heat from the heat collecting plate to the stone member.

14. The high altitude construction of claim 12, wherein the heating device further includes a heat extracting device that extracts heat from the heat reservoirs, wherein the heat extracting device includes a fluid tank and a plurality of heat extracting tubes connected to the fluid tank, wherein the fluid tank includes a first fluid chamber, a first fluid passage provided on the first fluid chamber, a second fluid chamber and a second fluid passage provided on the second fluid chamber, wherein each of the heat extracting tubes includes an inner tube and an outer tube, wherein the inner tube is positioned inside the outer tube for a predetermined length, wherein the inner tube includes a first end and a second end, wherein the outer tube includes a first end and a second end, wherein the first end of the inner tube is connected to the second fluid chamber and the first end of the outer tube is connected to the first fluid chamber, wherein the second end of the outer tube is communicatively connected to the second end of the inner tube.

15. The high altitude construction of claim 14, wherein the cross-section of the inner tube has a plurality of alternately positioned wings and recesses, and wherein the wings are inscribed to the inner surface of the outer tube.

16. The high altitude construction of claim 12, wherein the heating device further includes a plurality of geothermal heat transfer pipes connected to the air ducts.

17. The high altitude construction of claim 8, wherein the base further includes a hollow heat collecting tube having a predetermined length between the upper end of the tower and the conduit.

18. The high altitude construction of claim 17, wherein the hollow heat collecting tube is made of copper and painted black.

19. The high altitude construction of claim 17, wherein the heating device includes a plurality of reflectors that are arranged to reflect the sunlight to the heat collecting tube.

20. The high altitude construction of claim 2, wherein the heating device includes a means for collecting geothermal energy.

21. The high altitude construction of claim 1, wherein the base is installed on the sea surface, wherein the air raising device includes a underwater air circulation device, wherein the underwater air circulation device is vertically positioned under the base, wherein the underwater air circulation device intakes air on the sea surface, forms downward air flow by cooling the air by sea water, then forms upward air flow by reversing direction of the downward air flow, wherein the upward air flow is guided into the conduit.

22. The high altitude construction of claim 21, wherein the underwater air circulation device has an inner tube and an outer tube, wherein the inner tube is positioned inside the outer tube, wherein the upper end of the outer tube is open slightly above the sea surface so that air flows into the outer tube, wherein the lower end of the outer tube is communicatively connected to the lower end of the inner tube so that the direction of the downward air flow is reversed.

23. The high altitude construction of claim 22, wherein the lower end of the inner tube abuts the lower end of the outer tube, wherein the inner tube includes a plurality of holes near the lower end of the inner tube.

24. The high altitude construction of claim 22, wherein the outer tube of the underwater air circulation device has a plurality of heat transfer fins protruding into the space between the outer tube and the inner tube.

25. The high altitude construction of claim 24, wherein a predetermined number of the fins are extended to contact the inner tube whereby the inner tube is supported stably inside the outer tube.

26. The high altitude construction of claim 21, wherein the base further comprises a turbine and a generator connected to the turbine, and wherein the turbine is rotated by air flow in the conduit from the base to the buoyant device.

27. The high altitude construction of claim 21, wherein the conduit includes a plurality of wires, and a band wound around the wires.

28. The high altitude construction of claim 21, wherein the air raising device further includes a heating device for heating air, wherein air heated by the heating device passes through the conduit from the base to the buoyant device, wherein the heated air provides buoyant force to the buoyant device so that the buoyant device floats in the atmosphere and the conduit is suspended between the buoyant device and the base.

29. The high altitude construction of claim 28, wherein the heating device uses solar energy as an energy source.

30. The high altitude construction of claim 29, wherein the heating device further includes one or more burners that are installed inside the conduit.

31. The high altitude construction of claim 29, wherein the heating device includes a plurality of solar energy collectors, a plurality of heat reservoirs that are connected to the solar energy collectors and accumulate the collected solar energy, and a plurality of air ducts that connect the heat reservoirs to the tower.

32. The high altitude construction of claim 29, wherein the base further includes a hollow heat collecting tube having a predetermined length, wherein the heating device includes a plurality of reflectors that are arranged to reflect the sunlight to the heat collecting tube.

33. A high altitude platform comprising:
a) a plurality of high altitude constructions; and
b) a support member connecting the high altitude constructions;
wherein each of the high altitude constructions comprises a buoyant device, a base installed on the ground level, a conduit connecting the buoyant device and the base, and a heating device for heating air;
wherein air heated by the heating device passes through the conduit from the base to the buoyant device; and
wherein the heated air provides buoyant force to the buoyant device so that the buoyant device floats in the atmosphere and the conduit is suspended between the buoyant device and the base.

34. The high altitude construction of claim 33, wherein the support member is positioned near the buoyant devices of the high altitude constructions, wherein the support member includes a high altitude plate fixed thereto, and an aperture whereby one of the high altitude constructions can elevate cargos from the ground to the support member through the aperture.
